(19) United States
(12) Patent Application Publication
(10) Pub. No.: US 2012/0159083 A1
(43) Pub. Date: Jun. 21, 2012

(54) Systems and Methods for Processing Memory Transactions

(76) Inventors: Deniz Balkan, Santa Clara, CA (US); Gurjeet S. Saund, Saratoga, CA (US)

(21) Appl. No.: 12/971,779

(22) Filed: Dec. 17, 2010

(51) Int. Cl. G06F 12/08; G06F 12/00

(52) U.S. Cl. 711/141; 711/147; 711/E12.026; 711/E12.001

(57) ABSTRACT

Systems and methods for performing memory transactions are described. In an embodiment, a system comprises a processor configured to perform an action in response to a transaction indicative of a request originated by a hardware subsystem. A logic circuit is configured to receive the transaction. In response to identifying a specific characteristic of the transaction, the logic circuit splits the transaction into two or more other transactions. The two or more other transactions enable the processor to satisfy the request without performing the action. The system also includes an interface circuit configured to receive the request originated by the hardware subsystem and provide the transaction to the logic circuit. In some embodiments, a system may be implemented as a system-on-a-chip (SoC). Devices suitable for using these systems include, for example, desktop and laptop computers, tablets, network appliances, mobile phones, personal digital assistants, e-book readers, televisions, and game consoles.

### BACKGROUND

1. Field of the Invention

This invention is related to the field of processor implementation, and more particularly to systems and methods for processing memory transactions.

2. Description of the Related Art

Some computers feature memory access mechanisms that allow hardware subsystems or input/output (I/O) peripherals to access system memory without direct interference from a central processing unit (CPU) or processor. As a result, memory transactions involving these peripherals may take place while the processor continues to perform other tasks, thus increasing overall system efficiency. The use of such mechanisms, however, also presents the so-called “coherency problem.”

For example, in some situations, a processor may be equipped with a cache memory (e.g., L2 cache) and/or an external memory that may be accessed directly by peripherals. When the processor accesses a location in the external memory, its current value is stored in the cache. Ordinarily, subsequent operations upon that value would be stored in the cache but not in the external memory. Therefore, if a peripheral attempts to read the value from the external memory, it may receive an “old” or “stale” value. To avoid this situation, coherency may be maintained between values stored in cache and the external memory such that cache values are copied to the external memory before the peripheral tries to access them.

Coherency mechanisms may be implemented via hardware or software. In the case of hardware, a control unit may receive a request from a peripheral and then perform one or more operations that ensure coherency between the cache and the external memory. In the case of software, similar functionality may be implemented by an operating system. In a “directory-based coherence” system, for example, shared data may be placed in a directory that maintains coherence between a cache and an external memory. When an entry is changed in either memory, the directory may update and/or invalidate the corresponding entry in the other memory. Meanwhile, in a “snooping” system, a process monitors address lines for accesses to memory locations that are currently cached. When the process identifies a write operation to a location that is currently cached, the cache controller may invalidate its copy of the memory location.

These coherence mechanisms or controllers may typically be implemented within a processor complex as one or more circuits separate from (but often connected to) the processor. In this manner, hardware subsystems or peripherals may access system memory by interacting with the coherence controller and without direct involvement by the processor.

### SUMMARY

This specification discloses systems and methods for processing memory transactions. As such, systems and methods disclosed herein may be applied in various environments, including, for example, in computing devices that provide peripheral components with access to one or more memories. In some embodiments, systems and methods disclosed herein may be implemented in a system-on-a-chip (SoC) or application-specific integrated circuit (ASIC) such that several hardware and software components may be integrated within a single circuit. Examples of electronic devices suitable for using these systems and methods include, but are not limited to, desktop computers, laptop computers, tablets, network appliances, mobile phones, personal digital assistants (PDAs), e-book readers, televisions, video game consoles, etc.

In some embodiments, a system may include an interface circuit that is configured to receive a request originated by a hardware subsystem and to generate a transaction based on the request. For example, the request may be a cache line write request, the hardware subsystem may be a peripheral I/O device, and the transaction may be a coherent memory transaction. The system may also include a processor complex or fabric that is configured to perform a specified operation in response to receiving the transaction. For instance, the processor complex may include one or more processor cores, a snoop control unit, a cache controller, a cache, etc. In some embodiments, the specified operation may be undesirable, unintentional, or otherwise incidental to the execution of the underlying request. For example, when the request is a cache line write request, the specified operation may cause data corruption or the like.

The system may also include a logic circuit connected between the processor complex and the interface circuit. The logic circuit may be configured to receive the transaction and identify a characteristic of the transaction that would otherwise trigger the specified operation. For example, the characteristic may be a byte size of the transaction. Additionally or alternatively, the characteristic may be the status of strobe bits within the transaction. The logic circuit may also be configured to split the transaction into two or more other transactions in a manner that allows the processor complex to satisfy the request without causing it to perform the specified operation.

In other embodiments, a method may include receiving, from a coherent I/O interface (CIF), a transaction indicative of a request between a hardware subsystem and a memory. The method may also include detecting a characteristic of the transaction that would cause a processor complex to perform a particular operation. The method may further include splitting the transaction into two or more other transactions, where neither of the two or more other transactions has the characteristic. Then, the method may include transmitting the two or more other transactions to the processor complex. In this manner, the method may enable the processor complex to satisfy the request without triggering the particular operation.

### BRIEF DESCRIPTION OF THE DRAWINGS

The following detailed description makes reference to the accompanying drawings, which are now briefly described.

FIG. 1 is a block diagram of a processor according to certain embodiments.

FIG. 2 is a block diagram of a SoC according to certain embodiments.

FIG. 3 is a block diagram of a logic circuit according to certain embodiments.

FIG. 4 is a flowchart of a method for processing memory transactions according to certain embodiments.

FIG. 5 is a flowchart of a method for processing memory responses according to certain embodiments.

FIG. 6 is a block diagram of a computer system according to certain embodiments.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, ¶6 interpretation for that unit/circuit/component.

### DETAILED DESCRIPTION OF EMBODIMENTS

This specification is divided into sections to facilitate understanding of the materials that follow. First, the specification provides an overview of a processor and its operation. Then, the specification discloses logic circuits configured to process memory transactions, followed by an illustrative implementation. Lastly, the specification presents a computer and accessible storage medium that incorporate embodiments of the systems and methods described herein.

### A Processor

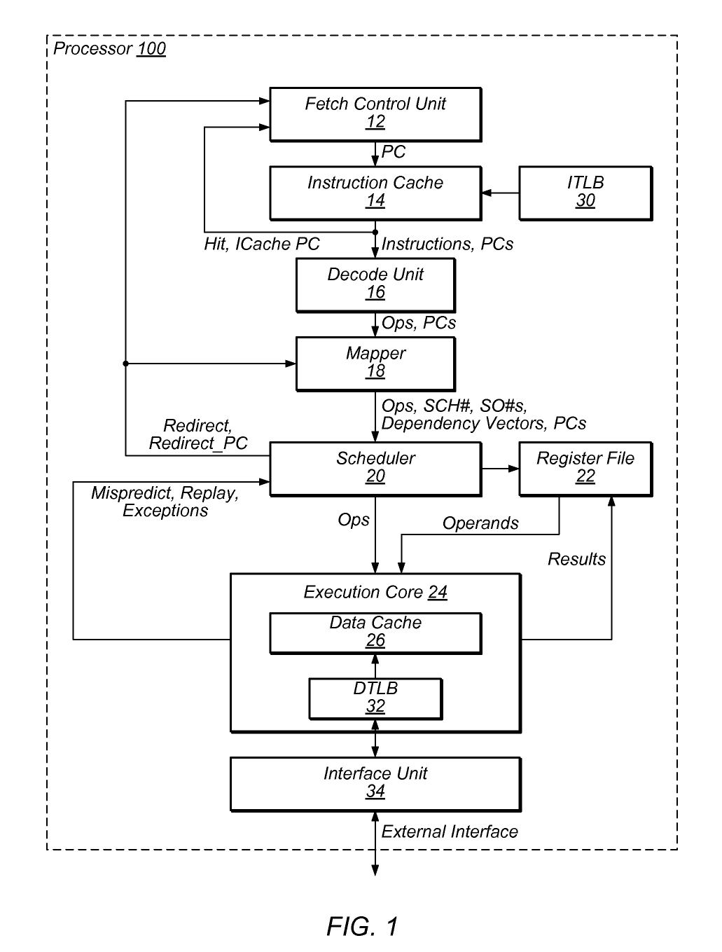

Turning to FIG. 1, a block diagram of a processor is shown. In various embodiments, processor 100 may be a microprocessor, microcontroller, central processing unit (CPU), or the like. As illustrated, processor 100 includes fetch control unit 12, instruction cache 14, decode unit 16, mapper 18, scheduler 20, register file 22, execution core 24, and interface unit 34. Fetch control unit 12 is coupled to provide a program counter address (PC) for fetching from instruction cache 14. Instruction cache 14 is coupled to provide instructions (with PCs) to decode unit 16, which is coupled to provide decoded instruction operations (ops, again with PCs) to mapper 18. Instruction cache 14 is further configured to provide a hit indication and an ICache PC to fetch control unit 12. Mapper 18 is coupled to provide ops, a scheduler number (SCH#), source operand numbers (SO#s), one or more dependency vectors, and PCs to scheduler 20. Scheduler 20 is coupled to receive replay, mispredict, and exception indications from execution core 24, is coupled to provide a redirect indication and redirect PC to fetch control unit 12 and mapper 18, is coupled to register file 22, and is coupled to provide ops for execution to execution core 24. Register file 22 is coupled to provide operands to execution core 24, and is coupled to receive results to be written to register file 22 from execution core 24. Execution core 24 is coupled to interface unit 34, which is further coupled to an external interface of processor 100.

Fetch control unit 12 may be configured to generate fetch PCs for instruction cache 14. In some embodiments, fetch control unit 12 may include one or more types of branch predictors. For example, fetch control unit 12 may include indirect branch target predictors configured to predict the target address for indirect branch instructions, conditional branch predictors configured to predict the outcome of conditional branches, and/or any other suitable type of branch predictor. During operation, fetch control unit 12 may generate a fetch PC based on the output of a selected branch predictor. If the prediction later turns out to be incorrect, fetch control unit 12 may be redirected to fetch from a different address. When generating a fetch PC, in the absence of a nonsequential branch target (i.e., a branch or other redirection to a nonsequential address, whether speculative or non-speculative), fetch control unit 12 may generate a fetch PC as a sequential function of a current PC value. For example, depending on how many bytes are fetched from instruction cache 14 at a given time, fetch control unit 12 may generate a sequential fetch PC by adding a known offset to a current PC value.

Instruction cache 14 may be a cache memory for storing instructions to be executed by the processor 100. Instruction cache 14 may have any capacity and construction (e.g., direct mapped, set associative, fully associative, etc.). Instruction cache 14 may have any cache line size. For example, 64 byte cache lines may be implemented in an embodiment. Other embodiments may use larger or smaller cache line sizes. In response to a given PC from fetch control unit 12, instruction cache 14 may output up to a maximum number of instructions. Processor 100 may implement any suitable instruction set architecture (ISA), such as, for example, a reduced instruction set computing (RISC), ARM® (a trademark of ARM Holdings), PowerPC® (a trademark of International Business Machines Corporation), x86 ISAs, or combinations thereof.

In some embodiments, processor 100 may implement an address translation scheme in which one or more virtual address spaces are made visible to executing software. Memory accesses within the virtual address space are translated to a physical address space corresponding to the actual physical memory available to the system, for example using a set of page tables, segments, or other virtual memory translation schemes. In embodiments that employ address translation, the instruction cache 14 may be partially or completely addressed using physical address bits rather than virtual address bits. For example, instruction cache 14 may use virtual address bits for cache indexing and physical address bits for cache tags.

In order to avoid the cost of performing a full memory translation when performing a cache access, processor 100 may store a set of recent and/or frequently-used virtual-to-physical address translations in a translation lookaside buffer (TLB), such as Instruction TLB (ITLB) 30. During operation, ITLB 30 (which may be implemented as a cache, as a content addressable memory (CAM), or using any other suitable circuit structure) may receive virtual address information and determine whether a valid translation is present. If so, ITLB 30 may provide the corresponding physical address bits to instruction cache 14. If not, ITLB 30 may cause the translation to be determined, for example by raising a virtual memory exception.

Decode unit 16 may generally be configured to decode the instructions into instruction operations (ops). Generally, an instruction operation may be an operation that the hardware included in execution core 24 is capable of executing. Each instruction may translate to one or more instruction operations which, when executed, result in the operation(s) defined for that instruction being performed according to the instruction set architecture implemented by processor 100. In some embodiments, each instruction may decode into a single instruction operation. Decode unit 16 may be configured to identify the type of instruction, source operands, etc., and the decoded instruction operation may include the instruction along with some of the decode information. In other embodiments in which each instruction translates to a single op, each op may simply be the corresponding instruction or a portion thereof (e.g., the opcode field or fields of the instruction). In some embodiments in which there is a one-to-one correspondence between instructions and ops, decode unit 16 and mapper 18 may be combined and/or decode and mapping operations may occur in one clock cycle. In other embodiments, some instructions may decode into multiple instruction operations. In some embodiments, decode unit 16 may include any combination of circuitry and/or microcoding in order to generate ops for instructions. For example, relatively simple op generations (e.g., one or two ops per instruction) may be handled in hardware while more extensive op generations (e.g., more than three ops for an instruction) may be handled in microcode.

Ops generated by decode unit 16 may be provided to the mapper 18. Mapper 18 may implement register renaming to map source register addresses from the ops to the source operand numbers (SO#s) identifying the renamed source registers. Additionally, mapper 18 may be configured to assign a scheduler entry to store each op, identified by the SCH#. In an embodiment, the SCH# may also be configured to identify the rename register assigned to the destination of the op. In other embodiments, mapper 18 may be configured to assign a separate destination register number. Additionally, mapper 18 may be configured to generate dependency vectors for the op. The dependency vectors may identify the ops on which a given op is dependent. In an embodiment, dependencies are indicated by the SCH# of the corresponding ops, and the dependency vector bit positions may correspond to SCH#s. In other embodiments, dependencies may be recorded based on register numbers and the dependency vector bit positions may correspond to the register numbers.

Mapper 18 may provide the ops, along with SCH#, SO#s, PCs, and dependency vectors for each op to scheduler 20. Scheduler 20 may be configured to store the ops in the scheduler entries identified by the respective SCH#s, along with the SO#s and PCs. Scheduler 20 may be configured to store the dependency vectors in dependency arrays that evaluate which ops are eligible for scheduling. Scheduler 20 may be configured to schedule the ops for execution in the execution core 24. When an op is scheduled, scheduler 20 may be configured to read its source operands from register file 22 and the source operands may be provided to execution core 24. Execution core 24 may be configured to return the results of ops that update registers to register file 22. In some cases, execution core 24 may forward a result that is to be written to register file 22 in place of the value read from register file 22 (e.g., in the case of back to back scheduling of dependent ops).

Execution core 24 may also be configured to detect various events during execution of ops that may be reported to the scheduler. Branch ops may be mispredicted, and some load/store ops may be replayed (e.g., for address-based conflicts of data being written/read). Various exceptions may be detected (e.g., protection exceptions for memory accesses or for privileged instructions being executed in non-privileged mode, exceptions for no address translation, etc.). The exceptions may cause a corresponding exception handling routine to be executed.

Execution core 24 may be configured to execute predicted branch ops, and may receive the predicted target address that was originally provided to the fetch control unit 12. In addition, execution core 24 may be configured to calculate the target address from the operands of the branch op, and to compare the calculated target address to the predicted target address to detect correct prediction or misprediction. Execution core 24 may also evaluate any other prediction made with respect to the branch op, such as a prediction of the branch op's direction. If a misprediction is detected, execution core 24 may signal that fetch control unit 12 should be redirected to the correct fetch target. Other units, such as scheduler 20, mapper 18, and decode unit 16 may flush pending ops/instructions from the speculative instruction stream that are subsequent to or dependent upon the mispredicted branch.

In some embodiments, execution core 24 may include data cache 26, which may be a cache memory for storing data to be processed by the processor 100. Like instruction cache 14, data cache 26 may have any suitable capacity, construction, or line size (e.g., direct mapped, set associative, fully associative, etc.). Moreover, data cache 26 may differ from instruction cache 14 in any of these details. As with instruction cache 14, in some embodiments, data cache 26 may be partially or entirely addressed using physical address bits. Correspondingly, data TLB (DTLB) 32 may be provided to cache virtual-to-physical address translations for use in accessing data cache 26 in a manner similar to that described above with respect to ITLB 30. It is noted that although ITLB 30 and DTLB 32 may perform similar functions, in various embodiments they may be implemented differently. For example, they may store different numbers of translations and/or different translation information.

Register file 22 may generally include any set of registers usable to store operands and results of ops executed in processor 100. In some embodiments, register file 22 may include a set of physical registers and mapper 18 may be configured to map the logical registers to the physical registers. The logical registers may include both architected registers specified by the instruction set architecture implemented by the processor 100 and temporary registers that may be used as destinations of ops for temporary results (and sources of subsequent ops as well). In other embodiments, register file 22 may include an architected register set containing the committed state of the logical registers and a speculative register set containing speculative register state.

Interface unit 24 may generally include the circuitry for interfacing the processor 100 to other devices on the external interface. The external interface may include any type of interconnect (e.g., bus, packet, etc.). The external interface may be an on-chip interconnect, if the processor 100 is integrated with one or more other components (e.g., a system on a chip configuration). The external interface may be an off-chip interconnect to external circuitry, if processor 100 is not integrated with other components. In various embodiments, processor 100 may implement any instruction set architecture.

### Processing Memory Transactions

In some embodiments, one or more processors similar to processor 100 may be placed within a processor fabric or complex. The processor complex may also include other components such as, for example, a coherency circuit or controller, which may enable hardware subsystems and/or peripherals to access system memory. In operation, memory “requests” originating from a hardware subsystem or peripheral may be processed, for example, by a coherent input/output (I/O) interface (CIF) of a central direct memory access (CDMA) controller and/or coherency bridge circuit. These requests may be transformed into memory “transactions,” which may be sent by the CIF to the coherency circuit within the processor complex. Additionally or alternatively, memory requests may be transmitted to the processor complex without modification. In any event, in some embodiments, one or more logic circuits may be configured to process certain memory requests or transactions communicated between the CIF and the processor complex.

In some cases, any number of peripherals, CIFs, logic circuits, processor complexes, and/or memories may be discrete, separate components. In other cases, these and other components may be integrated, for example, as system-on-chip (SoC), application-specific integrated circuit (ASIC), etc.

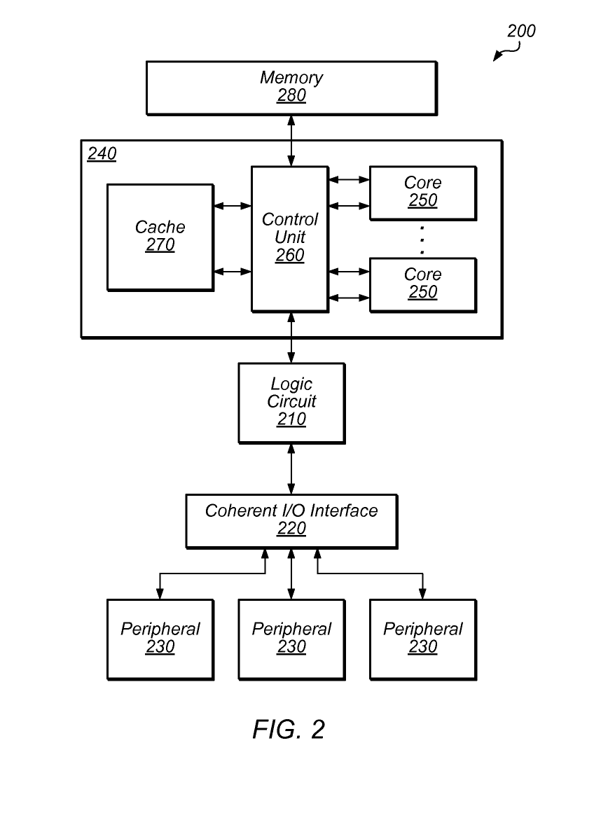

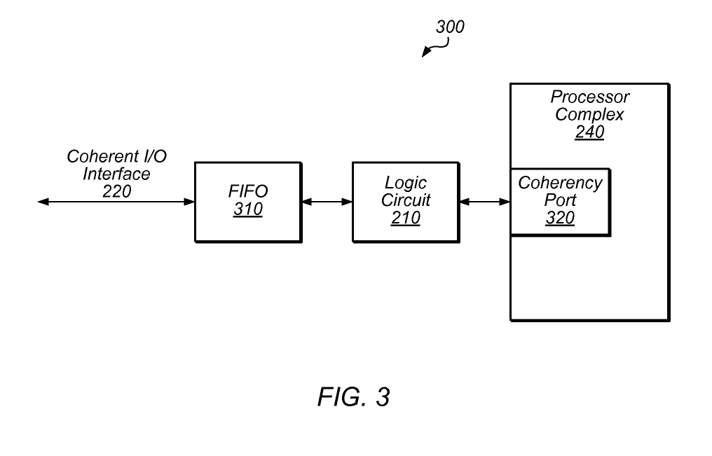

FIG. 2 shows a block diagram of a system-on-chip (SoC) according to certain embodiments. Processor complex 240 of SoC 200 may include one or more of the elements described as part of processor 100 of FIG. 1. As illustrated, processor complex 240 includes cache memory 270 (e.g., L2 cache) and a plurality of processor cores 250 coupled to control unit 260. In some embodiments, each of processor cores 250 may have its own cache (e.g., L1 cache). As shown in the illustrative implementation discussed below, examples of processor cores 250 may include ARM Holdings' Cortex™-A9 cores or the like, and examples of control unit 260 may include a Snoop Control Unit (SCU) or the like. In alternative implementations, however, other suitable components may be used. Control unit 260 may connect processor cores 250 to shared, external, or any other type of memory 280 (e.g., RAM) and/or cache 270. Further, control unit 260 may be configured to maintain data cache coherency among processor cores 250 and/or to manage accesses by external devices via its coherency port (shown in FIG. 3).

In some embodiments any number and/or types of cores, caches, and control units may be used. Furthermore, a number of additional logic components (not shown) may be part of processor complex 240 such as, for example, cache controllers, buffers, clocks, synchronizers, logic matrices, decoders, interfaces, etc.

Referring back to FIG. 2, processor complex 240 is coupled to logic circuit 210, which in turn is coupled to coherent input/output (I/O) interface (CIF) 220. As illustrated, one or more peripherals 230 are coupled to CIF 220. In some embodiments, CIF 220 may be part of a central direct memory access (CDMA) controller (not shown) or the like. In other embodiments, however, any other suitable type of memory access mechanism may be provided. Peripherals 230 may include any device configured to or capable of interacting with processor complex 240 and/or memories 270 and 280. Examples of peripherals 230 include audio controllers, video or graphics controllers, interface (e.g., universal serial bus or USB) controllers, etc.

Components shown within SoC 200 may be coupled to each other using any suitable bus and/or interface mechanism. In some embodiments, for example, such components may be connected using ARM Holdings' Advanced Microcontroller Bus Architecture (AMBA®) protocol or any other suitable on-chip interconnect specification for the connection and management of logic blocks. Examples of AMBA® buses and/or interfaces may include Advanced eXtensible Interface (AXI), Advanced High-performance Bus (AHB), Advanced System Bus (ASB), Advanced Peripheral Bus (APB), Advanced Trace Bus (ATB), etc.

In operation, peripherals 230 may have access to external memory 280, cache 270 and/or processor cores 250 through logic circuit 210. For example, peripherals 230 may transmit memory access requests (e.g., read or write) to CIF 220, and CIF 220 may in response issue corresponding memory transactions to control unit 260 of processor complex 240. In some embodiments, logic circuit 210 may be a programmable logic circuit or the like. Moreover, logic circuit 210 may comprise standard electronic components such as bipolar junction transistors (BJTs), field-effect transistors (FETs), other types of transistors, logic gates, operational amplifiers (op amps), flip-flops, capacitors, diodes, resistors, and the like. These and other components may be arranged in a variety of ways and configured to perform the various operations described herein.

FIG. 3 shows a block diagram of logic circuit 210 according to certain embodiments. As illustrated, logic circuit 210 is coupled to processor complex 240 via coherency port 320 of control unit 260 (shown in FIG. 1). Moreover, coherency port 320 may provide a mechanism for coherent I/O traffic to snoop the L1 and L2 caches within the memory hierarchy of processor complex 240. Logic circuit 210 is also coupled to CIF 220 via synchronous first-in-first-out (FIFO) circuit 310. In some embodiments, memory transactions provided by CIF 220 may be stalled within logic circuit 210 until all their data is available, in which case FIFO 310 may be used as data storage. In some cases, various components shown in FIG. 3 may operate within different voltage domains (e.g., V_{dd} SoC and V_{dd} CPU). Accordingly, in these cases, FIFO 310 may be implemented as an asynchronous FIFO. Once an entire memory transaction is received, logic circuit 310 may perform gather, split, and/or combine operations discussed in more detail below.

In some embodiments, processor complex 240 may be configured to perform one or more specified operations in response to receiving a memory transaction from CIF 220 through coherency port 320. In some cases, these operations may be undesirable, unintentional, or otherwise incidental to the execution of the underlying memory request originally transmitted by peripheral(s) 230. For example, when the memory transaction conveys a peripheral request that is a cache line write request, one such specified operation may cause data corruption or the like. In various embodiments, these operations may be triggered by a number of conditions or characteristics such as, for example, a particular byte size of the memory transaction, the status of strobe bits within or associated with the memory transaction, etc. Accordingly, in some embodiments, logic circuit 210 may be configured to detect one or more of these conditions and to modify the memory transaction in order to avoid an operation while satisfying the underlying request (e.g., performing a requested cache write without also causing data corruption, etc.). Moreover, logic circuit 210 may be a programmable circuit such that conditions and/or characteristics associated with memory transactions may be modified over time (e.g., as new conditions are discovered during use in the field).

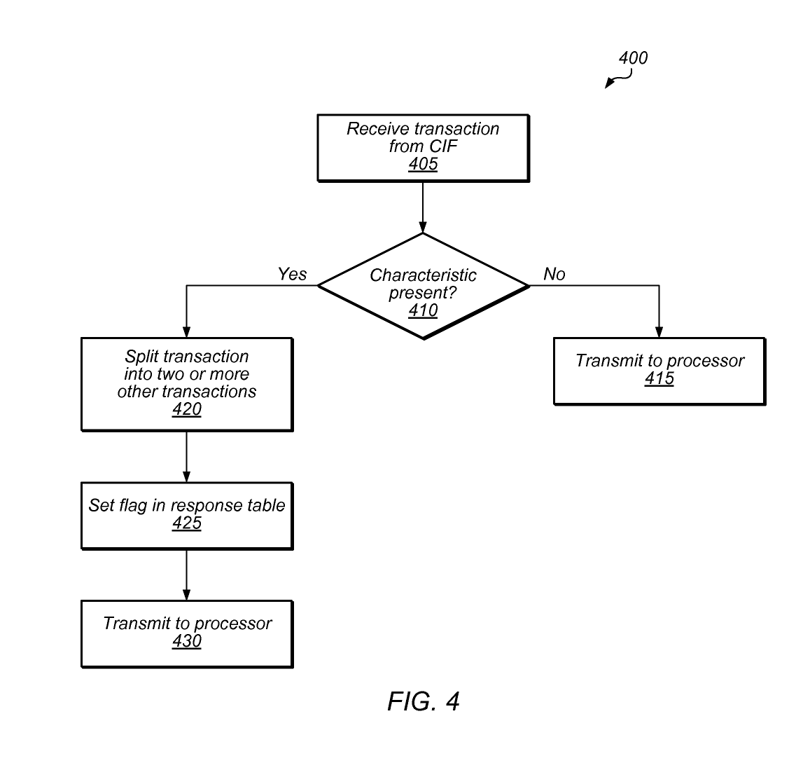

Referring to FIG. 4 a flowchart of a method for processing memory transactions is depicted according to certain embodiments. In some embodiments, method 400 may describe operations performed by logic circuit 210 when receiving memory transactions from CIF 220. Thus, at 405, method 400 may include receiving a memory transaction from CIF 220. As previously noted, this memory transaction may contain, encode, or otherwise represent a memory request issued by one or more peripheral components 230. At 410, method 400 may determine whether the original transaction meets one or more conditions or characteristics such as, for example, a particular byte size, strobe bits status, etc. If the transaction does not have the specified characteristics, then method 400 may transmit the original transaction to processor complex 240 at 415. For example, as noted above, if the memory transaction is a cache line write request having a particular byte size or strobe bit status, the operation may cause data corruption or the like.

If, on the other hand, the original transaction does have the specified characteristic, then method 400 may manipulate the transaction to remove the characteristic or otherwise avoid a corresponding processor complex 240 operation at 420. For example, when the characteristic is a specific byte size, method 400 may split the original transaction into two or more other transactions, each having a smaller byte size. At 425, method 400 may set a flag in a response table that indicates the original transaction or request has been split. In some embodiments, the response table may be an index table, a look-up table, or the like. The response table may store, for example, an original transaction ID corresponding to the IDs of the two or more other transactions. Then, at 430, method 400 may transmit the two or more other transactions to processor complex 240.

In some embodiments, because processor complex 240 cannot “see” or does not otherwise detect the characteristic in the two or more other transactions it actually receives, processor complex 240 does not perform the operation(s) that would otherwise have been triggered by that characteristic. In this manner, method 400 may allow the processor to satisfy the underlying memory request without causing it to perform the specified operation(s). For example, method 400 may cause processing complex 240 to perform a cache write without corrupting data.

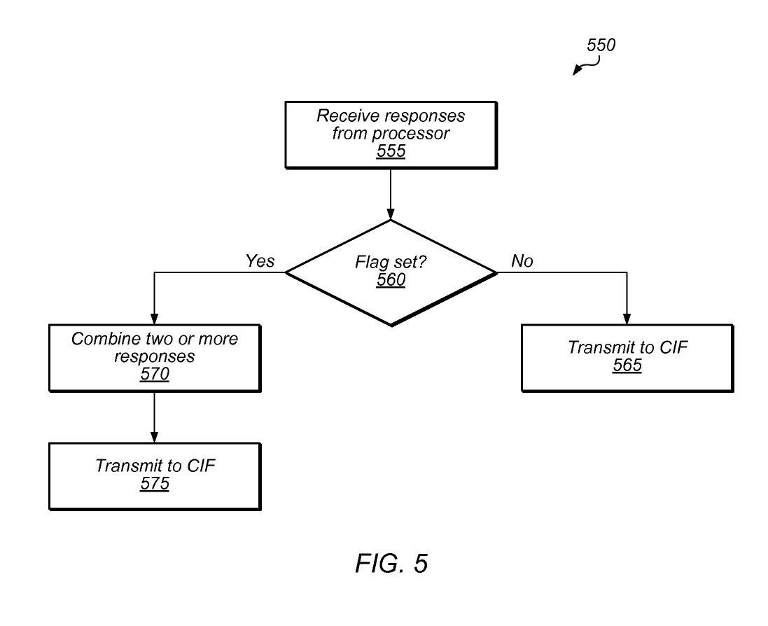

Referring now to FIG. 5, a flowchart of a method for processing memory transaction responses is depicted according to certain embodiments. In some embodiments, method 550 illustrates operations that may be performed by logic circuit 210 when receiving responses to memory transactions previously sent to processor complex 240. Hence, at 555, method 550 may receive one or more transaction responses. At 560, method 550 may check the response to table and compare transaction IDs to determine whether the received response corresponds to a transaction that was previously split into two or more other transactions. If the flag is not set, then the response is returned to CIF at 565.

However, if a flag is set, this may indicate that the response in fact corresponds to a previously split transaction. Therefore, at 570, method 550 combines two or more responses, for example, into a combined transaction response associated with the corresponding original transaction. Then, at 575, method 550 returns the combined transaction response to CIF 575. Accordingly, in some embodiments, memory transaction processing may be made transparent to processor complex 240, CIF 220 and/or peripherals 230.

In some embodiments, “combining” responses may involve discarding one of the responses. For example, consider a situation where an original transaction was split into first and second transactions by logic circuit 210 before being transmitted to processor complex 240. In this case, if a first response indicates that first transaction was successfully completed and a second response indicates a second transaction was unsuccessful, then the “combined” response may be just the second response. Furthermore, in some embodiments, if the first response is unsuccessful, then logic circuit 210 may return the first response immediately without having to wait for second response—i.e., the second response is irrelevant insofar as the “combination” of an unsuccessful response with any other response would also be an unsuccessful response. These and other illustrative implementations are discussed in more detail below.

### An Illustrative Implementation

This section discusses an illustrative implementation of systems and methods described herein for illustration purposes. In this particular implementation, processing complex 240 includes the ARM Holding's Cortex™-A9 processor and control unit 260 includes a Snoop Control Unit (SCU). In this processor, there may be situations where the ACP port (corresponding to coherency port 320 in FIG. 3) can only accept cache line write requests with all of its strobe bits set to “1”—i.e., the ACP port does not gracefully accept a write where some bytes are not written. Thus, in these situations, if one or more strobe bits are set to “0” (i.e., “not set”), data corruption may result.

Specifically, when there is an “optimized” write transaction at the ACP port, the processor complex writes the entire cacheline (corresponding to cache 270 in FIG. 2) without checking the strobe (STRB) bits. In some cases, however, certain STRB bits may intentionally not have been set—i.e., they are “set” to “0”—which indicates that corresponding bytes should not be written (or overwritten). Nonetheless, because the processor complex writes the line for “optimized transactions” without checking STRB bits, the entire cache line is rewritten, including bytes for which corresponding STRB bits are “0.” As a result, data corruption occurs in cache 270 and is later propagated to memory 280.

Because the cache line size is 32B, an “optimized” request may be defined using the following write address channel (AW) criteria:

1. AWUSER[0]-1 (Shared), AWBURST=INCR, AWSIZE=8B and AWLEN=4 beats with address aligned on 32B boundary; and/or

2. AWUSER[0]-1 (Shared), AWBURST=WRAP, AWSIZE=8B and AWLEN=4 beats with address aligned on 8B boundary.

Such criteria may be programmed in logic circuit 210. In this implementation, if not all the strobe bits of write data are set, logic circuit 210 may break up received transactions as listed in Table I below. Other fields of the split transactions may remain the same as in the original transaction.

TABLE I

| Original Transaction | | | | Split Transcations | | | |
|---|---|---|---|---|---|---|---|
| Address | Burst | Size | Length | Address | Burst | Size | Length |
| 5′b0_0000 | INCR | 8 B | 4 | 5′b0_0000 | INCR | 8 B | 2 |
| | | | | 5′b1_0000 | INCR | 8 B | 2 |
| 5′b0_0000 | WRAP | 8 B | 4 | 5′b0_0000 | INCR | 8 B | 2 |
| | | | | 5′b1_0000 | INCR | 8 B | 2 |
| 5′b0_1000 | WRAP | 8 B | 4 | 5′b0_1000 | INCR | 8 B | 3 |
| | | | | 5′b0_0000 | INCR | 8 B | 1 |
| 5′b1_0000 | WRAP | 8 B | 4 | 5′b1_0000 | INCR | 8 B | 2 |
| | | | | 5′b0_0000 | INCR | 8 B | 2 |
| 5′b1_1000 | WRAP | 8 B | 4 | 5′b1_1000 | INCR | 8 B | 1 |
| | | | | 5′b0_0000 | INCR | 8 B | 3 |

In Table I above, the 5-bit address fields represents the lower 5-bits of a possibly wider address bus (i.e., the address are not limited to being only 5-bits wide). Furthermore, because in this case each original transaction is split into two other transactions, transaction responses may be combined, for example, based on Table II below:

TABLE II

| 1st Write | 2nd Write | Combined |
|---|---|---|
| Response | Response | Response |
| OKAY/EXOKAY | OKAY/EXOKAY | OKAY |
| OKAY/EXOKAY | SLVERR | SLVERR |
| SLVERR | OKAY/EXOKAY | SLVERR |
| SLVERR | SLVERR | SLVERR |
| DECERR | OKAY/EXOKAY | DECERR |
| OKAY/EXOKAY | DECERR | DECERR |
| DECERR | DECERR | DECERR |

In other words, the combined transaction response may be positive (e.g., OKAY) only if the responses from the first and second split transactions are both without errors (e.g., a slave error (e.g., SLVERR) or a decode error (e.g., DECERR)). Furthermore, if one of the split transaction responses is positive but the other has a given error, the combined response indicates that error (e.g., SLVERR or DECERR).

In some embodiments, logic circuit 210 may include a 4-entry synchronous

FIFO on a write data path (i.e., one entry for each “beat”). Such FIFO may be instantiated, for example, after FIFO 310 shown in FIG. 3. Further, the FIFO may be wide enough to accommodate 64b-data, 8b-strobe, write-ID, and other associated bits. The strobes of the write data may be observed as the data moves into the FIFO, and the data may be stalled in the FIFO, for example, if the transaction is “optimized” and does not have all strobe bits set.

Once the data is stalled and/or detected in the FIFO using the “optimized” transaction criteria outlined above, logic circuit 210 may create two transactions according to Table I. Then, logic circuit 210 may set a write bit for the last data beat of the “first” new transaction. Also, logic circuit 210 may set a flag in a response table to indicate the presence of an original memory transaction with two responses.

The response table may be 8 FIFOs of 8×1b. Each FIFO may correspond to the 8 possible IDs which may be outstanding to the ACP. Because in this example there can be a maximum of 8 writes outstanding, each FIFO has 8 entries. A FIFO is written to when a request is made with the corresponding ID. The value written is “0” if it is a pass-through (i.e., unaltered or original) transaction and “1” if it is a split transaction. The FIFO is read each time a write response is received. If the value read is “0,” then the write response is forwarded to the CIF. In the case the value read is “1,” then the write response is dropped, and only the next write response is forwarded to the CIF. Additionally or alternatively, both responses may be examined and combined as shown in Table II above.

### A Computer System and Storage Medium

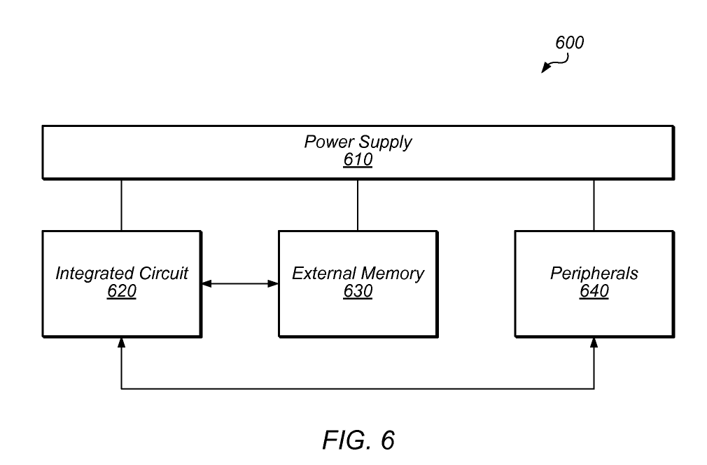

In some embodiments, a computer and accessible storage medium may incorporate embodiments of the systems and methods described herein. Turning next to FIG. 6, a block diagram of such system is shown. As illustrated, system 600 includes at least one instance of integrated circuit 620. Integrated circuit 620 may include one or more instances of processor 100 (from FIG. 1), processor complex 240 (from FIG. 2), and/or a combination of processor complex 240 with other logic circuitry (from FIG. 3). In some embodiments, integrated circuit 620 may be a system on a chip (SoC) including one or more instances of processor 100 and various other circuitry such as a memory controller, video and/or audio processing circuitry, on-chip peripherals and/or peripheral interfaces to couple to off-chip peripherals, etc. Integrated circuit 620 is coupled to one or more peripherals 640 (e.g., peripherals 230 in FIG. 2) and external memory 630 (e.g., memory 280 in FIG. 2). Power supply 610 is also provided which supplies the supply voltages to integrated circuit 620 as well as one or more supply voltages to memory 630 and/or peripherals 640. In some embodiments, more than one instance of the integrated circuit 620 may be included (and more than one external memory 630 may be included as well).

Peripherals 640 may include any desired circuitry, depending on the type of system 600. For example, in an embodiment, system 600 may be a mobile device (e.g. personal digital assistant (PDA), smart phone, etc.) and peripherals 640 may include devices for various types of wireless communication, such as wifi, Bluetooth, cellular, global positioning system, etc. Peripherals 640 may also include additional storage, including RAM storage, solid state storage, or disk storage. Peripherals 640 may include user interface devices such as a display screen, including touch display screens or multitouch display screens, keyboard or other input devices, microphones, speakers, etc. In other embodiments, system 600 may be any type of computing system (e.g., desktop and laptop computers, tablets, network appliances, mobile phones, personal digital assistants, e-book readers, televisions, and game consoles).

External memory 630 may include any type of memory. For example, external memory 630 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, RAMBUS DRAM, etc. External memory 630 may include one or more memory modules to which the memory devices are mounted, such as single inline memory modules (SIMMs), dual inline memory modules (DIMMs), etc.

Numerous variations and modifications will become apparent to those skilled in the art once the above disclosure is fully appreciated. It is intended that the following claims be interpreted to embrace all such variations and modifications.

1. A method, comprising:
receiving, via a coherent input/output interface (CIF), a cache line write transaction corresponding to a request from a hardware subsystem to a memory;
detecting a characteristic of the cache line write transaction, wherein the characteristic includes at least one of a byte size of the cache line write transaction and a status of strobe bits within the cache line write transaction, and wherein the cache line write transaction is configured such that, upon being received by a processor complex, the characteristic of the cache line write transaction causes the processor complex to corrupt data;
splitting the cache line write transaction into two or more other write transactions in response to detecting the characteristic, wherein neither of the two or more other write transactions has the characteristic;
transmitting the two or more other write transactions to the processor complex, wherein the two or more other write transactions cause the processor complex to satisfy the request without corrupting the data;
receiving, from the processor complex, two or more write responses corresponding to the two or more other write transactions;
combining the two or more write responses into a single write response; and
transmitting the single write response to the CIF.

2. A method, comprising:
receiving, from an I/O interface, a transaction indicative of a request between a hardware subsystem and a memory;
detecting a characteristic of the transaction, wherein the characteristic causes a processor complex to perform an operation;
splitting the transaction into two or more other transactions in response to detecting the characteristic, wherein neither of the two or more other transactions has the characteristic; and
transmitting the two or more other transactions to the processor complex, wherein the two or more other transactions cause the processor complex to satisfy the request without performing the operation.

3. The method of claim 2, wherein the transaction comprises a cache line write transaction.

4. The method of claim 2, wherein the hardware subsystem comprises a peripheral device.

5. The method of claim 2, wherein the characteristic of the transaction comprises a byte size of the transaction.

6. The method of claim 2, wherein the characteristic of the transaction comprises a status of strobe bits within the transaction.

7. The method of claim 2, wherein the processor complex comprises one or more processor cores.

8. The method of claim 2, wherein the operation comprises an unintended operation.

9. The method of claim 2, wherein the operation causes corruption of data.

10. The method of claim 2, further comprising:
receiving, from the processor complex, two or more responses corresponding to the two or more other transactions;
combining the two or more responses into a single response; and
transmitting the single response to the I/O interface.

11. A system-on-a-chip (SoC), comprising:
a processor complex configured to perform an action in response to a transaction indicative of a request originated by a hardware subsystem;
a logic circuit coupled to the processor complex, wherein the logic circuit, during operation, receives the transaction and, in response to identifying a specific characteristic of the transaction, splits the transaction into two or more other transactions such that, in response to receiving the two or more other transactions, the processor complex, during operation, satisfies the request without performing the action; and
an interface circuit coupled to the logic circuit, wherein the interface circuit, during operation, receives the request originated by the hardware subsystem and provides the transaction to the logic circuit.

12. The system of claim 11, wherein the request is a cache line write request.

13. The system of claim 11, wherein the characteristic of the transaction is indicated by at least one of: a byte size of the transaction or a status of strobe bits within the transaction.

14. The system of claim 11, wherein the operation causes corruption of data.

15. The system of claim 11, wherein the logic circuit, during operation, receives two or more responses corresponding to the two or more other transactions, combines the two or more responses into a single response, and transmits the single response to the interface circuit.

16. A logic circuit comprising:
a buffer configured to store an original transaction comprising a memory request originated by a peripheral device; and
a transaction splitter coupled to the buffer, wherein the transaction splitter is configured to receive the original transaction from the buffer and, in response to identifying a size of the original transaction, split the original transaction into two or more other transactions, each of the two or more other transactions having sizes different than the size of the original transaction.

17. The logic circuit of claim 16, wherein the transaction splitter is coupled to a processor complex and wherein the processor complex is configured to satisfy the memory request without performing an operation corresponding to the original transaction in response to receiving the two or more other transactions.

18. The logic circuit of claim 16, wherein the request comprises a cache line write request.

19. The logic circuit of claim 16, wherein the operation causes corruption of data.

20. The logic circuit of claim 16, the logic circuit further comprising:
a response combiner configured to receive two or more responses corresponding to the two or more other transactions, combine the two or more responses into a single response, and transmit the single response to the interface circuit.
